(19) United States
(12) Patent Application Publication
(10) Pub. No.: US 2026/0368715 A1
(43) Pub. Date: Nov. 19, 2026

(54) SECURE VEHICLE-TERMINAL TRANSACTION PROCESSING

(71) Applicant: Cardtronics USA, Inc., Atlanta, GA (US)

(72) Inventor: Anthony Edward Roper, Argus (GB)

(21) Appl. No.: 19/208,834

(22) Filed: May 15, 2025

(51) Int. Cl. G06Q 20/32; G06Q 20/40; G10L 15/22

(52) U.S. Cl. CPC G06Q 20/3226; G06Q 20/4012; G06Q 20/40145; G10L 15/22; G10L 2015/223

(57) ABSTRACT

Methods and system for conducting financial transactions at a terminal using vehicle-based authentication and interaction. The methods and system leverage a registered vehicle's communication systems and a user's mobile device for multi-factor authentication. The terminal establishes secure communication with the vehicle's systems through Bluetooth® or Wi-Fi connections, utilizing unique identifiers and encryption. Users can interact with the terminal through the vehicle's audio system and microphone, enabling voice commands and audio feedback. The methods and system support enhanced accessibility features and provides a more transaction experience while maintaining security through multiple authentication factors.

### BACKGROUND

Drive-up automated teller machines (ATMs) traditionally rely on physical cards and personal identification numbers (PINs) for customer authentication and transaction processing. This authentication approach presents challenges for accessibility, particularly for individuals with physical limitations or those who may have difficulty reaching the ATM interface from their vehicle. Additionally, the conventional ATM interface can be impersonal and limiting in terms of available functions and interaction methods. Furthermore, customers at electric vehicle charging stations often need to exit their vehicles to conduct ATM transactions, which can be inconvenient and potentially unsafe.

### BRIEF DESCRIPTION OF THE DRAWINGS

FIG. 1 is a diagram of a system for secure vehicle-terminal transaction processing, according to an example embodiment.

FIG. 2 is a flow diagram of a method for secure vehicle-terminal transaction processing, according to an example embodiment.

FIG. 3 is a flow diagram of another media for secure vehicle-terminal transaction processing, according to an example embodiment.

### DETAILED DESCRIPTION

Financial transaction terminals, particularly drive-up ATM terminals, face several critical challenges in today's banking environment. The physical constraints of reaching from a vehicle to interact with a terminal's interface can create difficulties for many users, including those with mobility limitations or those whose vehicle positioning makes interaction awkward or uncomfortable. Current authentication methods at these terminals rely heavily on physical cards and PINs, which can be compromised and do not take advantage of modern security capabilities. Additionally, the standard visual interface-based interaction model fails to accommodate users with visual impairments and does not leverage the sophisticated communication systems present in modern vehicles.

In an embodiment, a terminal establishes a secure connection with a user's vehicle through Bluetooth® or Wi-Fi communication protocols, utilizing unique identifiers such as VINs (vehicle identification number) or MAC (media access control) addresses combined with encryption keys. The user initiates the interaction through either their mobile banking application or the vehicle's built-in interface system.

In various embodiments presented herein, authentication occurs through multiple factors, including biometric verification through the mobile application, verification of the vehicle's unique identifiers, and/or proximity-based authentication using wireless signal strength measurements. The terminal interfaces with the vehicle's audio system, enabling voice-based commands and providing audio feedback through the vehicle's speakers, creating a secure, enclosed environment for conducting transactions. This integration with the vehicle's systems provides enhanced accessibility features while maintaining security through encrypted communications and continuous monitoring of authentication factors throughout the transaction session.

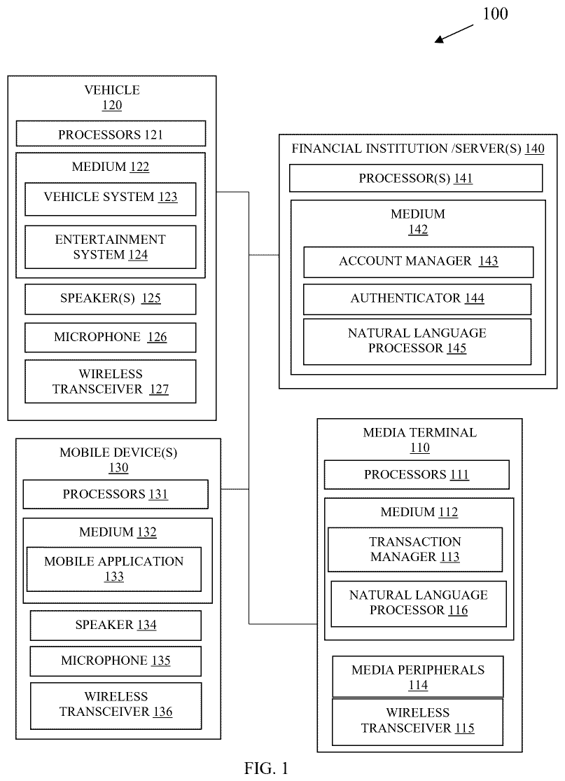

FIG. 1 is a diagram of a system f100 or secure vehicle-terminal transaction processing, according to an example embodiment. Notably, the components are shown schematically in simplified form, with only those components relevant to understanding of the embodiments being illustrated.

Furthermore, the various components (that are identified in system 100) are illustrated and the arrangement of the components are presented for purposes of illustration only. Notably, other arrangements with more or less components are possible without departing from the teachings presented herein and below.

System 100 includes a media terminal 110, a vehicle 120, a mobile device 130, and a financial institution (FI) server 140. The media terminal includes at least one processor 111 and a non-transitory computer-readable storage medium (medium) 112, which includes instructions for a transaction manager 113 and optional a natural language processor 116. The instructions when executed by the processor 111 cause the processor to perform the operations discussed herein and below with respect to transaction manager 113 and natural language processor 145. The media terminal 110 further includes media peripherals 114 including a media depository/recycler for depositing and dispensing cash, a card reader, a touchscreen, a receipt printer, etc. The media terminal 110 also includes a wireless transceiver 115 for wireless communications between the media terminal and the vehicle 120 and/or mobile device 130.

The vehicle 120 includes at least one processor 121 and a medium, which includes instructions for a vehicle system 123 and/or an entertainment system 124. The instructions when executed by the processor 121 cause the processor 121 to perform operations discussed herein and below with respect to vehicle system 123 and entertainment system 124. Vehicle 120 further includes one or more speakers 125, a microphone 126, and a wireless transceiver 127.

Each mobile device 130 includes at least one processor 131 and medium 132, which includes instructions for a mobile application 133. The instructions when executed by the processor 131 cause the processor 131 to perform operations discussed herein and below with respect to mobile application 133. The mobile device 130 further includes a speaker 134, a microphone 135, and a wireless transceiver 136. It is noted that the mobile device 130 may also include one or more integrated cameras.

Each FI server 140 includes at least one processor 141 and a medium, which includes instructions for an account manager 143, an authenticator 144, and optionally, a natural language processor 145. The instructions when executed by the processor 141 cause the processor 141 to perform the operations discussed herein and below with respect to account manager 143, authenticator 144, and natural language processor 145.

The media terminal 110 performs media-based transaction associated with valuable media, such as cash, banknotes, checks, etc. A media depository/recycler stores the valuable media within media cassettes. Transaction manager 113 interacts with account manager 143 and authenticator 144 during a media-based transaction to receive authorization and to authenticate a user's account for the transaction at the media terminal 110. During a dispense operation, cash is moved from corresponding media cassettes and dispensed to the user. During a deposit operation, cash and/or checks are moved from a media infeed to corresponding media cassettes that house cash or checks.

During operation of system 100, a user within a vehicle 120 approaches a drive-up or drive-thru media terminal 110 for the purposes of conducting a media-based transaction at the media terminal 110 while remaining inside the vehicle 120. The user accesses the mobile application 133 on the mobile device 130 and logs into to the user's account with account manager 143. Previously, the user has used the mobile application 133 to register the vehicle 120 including its VIN for perform secure in-vehicle transactions at drive-up media terminals 110. The mobile device 130 of the user may or may not be connected wirelessly to the vehicle system 123 of the vehicle 120. The connection may be through wireless Bluetooth® to the vehicle system 123.

Once the user is logged into the user's account, the user requests through the mobile application 133 a wireless connection to the mobile terminal 110. In an embodiment, the user then authorizes the wireless transceiver 127 of the vehicle 120 to be used as an additional factor in authentication for a wireless connection to the mobile terminal 110. Ince connected the vehicle's audio systems (e.g., entertainment system 124, speaker(s) 125, and/or microphone 126) to be leverages to allow for interaction with the media terminal 110 in various manners. For example, speaker(s) 125 may be used to provide audio-descriptive output from the transaction interface menu of the media terminal 110, which would assist those impaired in hearing or those who are partially sighted (partial sight does not necessarily mean that the user cannot drive; furthermore, the user may be a passenger in the vehicle 120 and not the driver of the vehicle 120). Microphone 126 may be used to take voice input and speech-based instruction directed to the media terminal 110 during the transaction.

During the establishment of the wireless connection, unique vehicle information is used or unique wireless transceiver information as an additional factor for authentication the user for using the media terminal 110 from the vehicle 120. For example, the vehicle's VIN may be saved within the mobile application 133 and transmitted during pairing, or a MAC address of the wireless transceiver 127 may be used. That is, not only is the user authenticated for access to the user's account but the vehicle 120 or the mobile device 130 within the vehicle is authenticated for wireless access to the media terminal 110.

In an embodiment, a combination of data and rules are used for authentication the user's vehicle 120. For example, a UUID for wireless transceiver 127 or 136 may be used, a MAC address of wireless transceivers 127 or 136, a hash of any of the above information combined with a current date and time of day, etc. In an embodiment, public-private key pairs are used during the secure wireless connection to encrypt the communications.

In an embodiment, the speaker 134 and microphone 135 of the mobile device 130 are used during the secure wireless connection between the user and the media terminal 110. That is, communication between the user and the media terminal 110 can occur via just the mobile device 130, the vehicle system 123, the vehicle entertainment system 124, or through both all of these.

In an embodiment, when the user logs in through the mobile application 133 to their account, the credentials supplied by the user may include a PIN, biometrics, or both a PIN and biometrics. When biometrics are required, the microphone 126, microphone 135, an integrated camera of mobile device 130, or a camera of vehicle 120 may be used to capture the biometrics, such as facial image.

In an embodiment, transaction manager 113 further performs a proximity-based authentication as a further factor in authenticating the user to access the media terminal 110 via the vehicle 120 for a media-based transaction. Here, transaction manager 113 utilizes wireless signal data from wireless transceiver 115 to measure the signal strength of the wireless connection requests and calculate a distance between the vehicle 120 and the media terminal 110. When the distance is not within a predefined and preconfigured threshold distance, the transaction manager 113 denies the wireless connection.

In an embodiment, the user interacts with the media terminal 110 during a transaction session over a secure and multi-factor authenticated connection using natural language voice through microphone 126 and/or microphone 135 and the media terminal responds with natural language voice output played over speaker 125 and/or speaker 134. Media terminal 110 processes and converts received speech or audio to natural language responses through natural language processor 116 or natural language processor 145.

In an embodiment, the transaction manager 113 provides both natural language output and application-based output to the user through the user interface of mobile application 133. So, the user can hear natural language responses through speaker(s) 125 or speaker 134 and see responses through the user interface of mobile application 133.

In an embodiment, the vehicle system 123 or entertainment system 124 includes a touch screen display such that text based output provided by media terminal 110 during the transaction session may also be displayed on the touch screen display. Similarly, the user may provide touch input instructions via the vehicle's touch screen display.

In an embodiment, system 100 is not restricted to media-based transactions for cash withdrawals and deposits, rather, system 100 may be used to book appointments with financial advisors, establish calls or schedule calls with tellers, etc. For example, a user pay be charging their electric vehicle at a charging station in close proximity to media terminal 110, connect to the media terminal 110 and check on the user's account balances, or even contact tellers associated with a bank of the media terminal 110.

In an embodiment, the system enables users to conduct banking transactions while charging their electric vehicles. A user parked at a charging station within range of media terminal 110 can connect securely through their vehicle system 123 or mobile application 133 to check account balances, schedule appointments with financial advisors, or interact with virtual teller avatars through the vehicle's audio system. This provides enhanced convenience and security during otherwise idle charging periods.

System 100 provides a unique interface with flexibility for interacting with drive-up media terminals by permitting fully integrated operations while the user remains within their vehicle 120. This is achieved via the microphone 126, microphone 135, speaker(s) 125, speaker 134, wireless transceiver 127, wireless transceiver 136, wireless transceiver 115, mobile application 133, transaction manager 113, an in-vehicle touch screen display, natural language processor 116, and/or natural language processor 145. Furthermore, the system provides enhanced security by using vehicle specific VINs, using unique information regarding the wireless transceivers (127, 136), and using custom encryption for purposes of initially authenticating the user for in-vehicle interaction with the media terminal 110, establishing a secure wireless connection to the media termina 110, and monitoring and maintaining the security of the wireless connection during a transaction session. User speech and interaction is private within the vehicle especially when the windows are rolled up such that eavesdroppers cannot hear what the user is saying during the transaction session. Moreover, an entire media transaction for a cash dispense operation can be completed by the user within the vehicle 120 and all the user does is roll down the window and take the dispensed cash. This provides the user with greater personal security during a transaction at a drive-up media terminal 110.

In an embodiment, the system integrates with automated intelligence-based (Al-based) virtual teller avatars to provide personalized assistance through the vehicle's audio system. This creates an experience similar to a traditional drive-up teller window, where users can speak naturally with a virtual representative while remaining securely in their vehicle. The virtual teller interaction is conducted through the encrypted connection, utilizing the vehicle's speakers and microphone for clear, private communication.

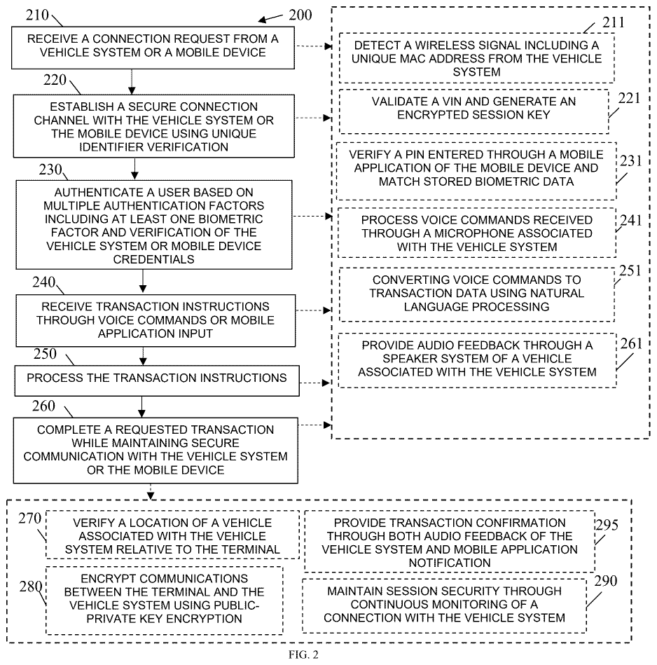

FIG. 2 is a flow diagram of a method 200 for secure vehicle-terminal transaction processing, according to an example embodiment. The instructions of method 200 are referred to secure terminal transaction manager. The secure terminal transaction manager is executed by one or more processors of a media terminal 110. In an embodiment, the secure terminal transaction manager is one or more of transaction manager 143.

At 210, the secure terminal transaction manager receives a connection request from a vehicle system 123 of a vehicle 120 or from a mobile application (app) 133 of a mobile device for purposes of conducting a transaction at a media terminal 110. In an embodiment, at 211, the secure terminal transaction manager detects a wireless signal, via wireless transceiver 115, the wireless signal includes a unique MAC address from the vehicle system 123.

At 220, the secure terminal transaction manager establishes a secure connection channel with the vehicle system 123 or the mobile app 133. The secure connection channel is between the user inside the vehicle 120 and method 200 being executed by media terminal 110. In an embodiment, the secure terminal transaction manager validates a VIN for the vehicle 120 as being a registered VIN associated with the user who is also registered for in-vehicle transaction processing at media terminal 110. The secure terminal transaction manager generates an encrypted session key for a secure connection over the secure connection channel.

At 230, the secure terminal transaction manager authenticates the user based on multiple authentication factors. The multiple authentication factors include at least one biometric factor associated with the user and verification of the vehicle system 123 or mobile device credentials. In an embodiment, at 231, the secure terminal transaction manager verifies a PIN entered through the mobile application 133 and batches user-provided biometric data against store biometric data, which is registered to the user. It is noted that the stored biometric data may be biometric measurements and not the user's actual biometric data. This ensures biometric data privacy for registered users of the secure in-vehicle and media terminal transaction processing.

At 240, the secure terminal transaction manager receives transaction instructions through voice commands received over a microphone 126 associated with vehicle system 123 received over a microphone 135 associated with mobile app 133. In an embodiment, the transaction instructions are received through mobile application input provided through text by the user into a user interface of the mobile app 133. In an embodiment, the vehicle system 123 includes a touch screen and the transaction instructions are inputted by the user through the touch screen of the vehicle system 123. In an embodiment, at 241, the secure terminal transaction manager processes voice commands received through microphone 126 associated with the vehicle system 123. converts the user's voice input into a text version of the transaction instructions.

At 250, the secure terminal transaction manager processes the transaction instructions. In an embodiment, at 251, the secure terminal transaction manager converts the user's voice commands into a text version of transaction data using natural language processor 116 or 145.

At 260, the secure terminal transaction manager completes a requested transaction while maintaining secure communication with the vehicle system 123 or the mobile application 133 of the mobile device 130. In an embodiment, at 261, the secure terminal transaction manager provides audio feedback through a speaker system or one or more speakers 125 of the vehicle 120.

In an embodiment, at 270, the secure terminal transaction manager verifies a location of the vehicle 120 relative to the media terminal 110. This can be done by evaluating the wireless signal strength between transceiver 127 of vehicle 120 or transceiver 136 of mobile device 130 over the secure connection relative to wireless transceiver 115 of media terminal 110.

In an embodiment, at 280, the secure terminal transaction manager encrypts communications between the terminal and the vehicle system 123 or mobile application 133 using public-private key encryption. The vehicle system 123 or mobile application 133 includes a private key and a public key and the secure terminal transaction manager maintains a private key and a public key. The key pairs are used during the secure connection to encrypt communications between the vehicle 120 or mobile device 130 and media terminal 110.

In an embodiment, at 290, the secure terminal transaction manager maintains session security for the secure transaction trough continuous monitoring of the secure connection with the vehicle system 123 or the mobile application 133. In an embodiment, at 295, the secure terminal transaction manager provides transaction confirmation through both audio feedback of the vehicle system 123 and through text-based mobile application notification.

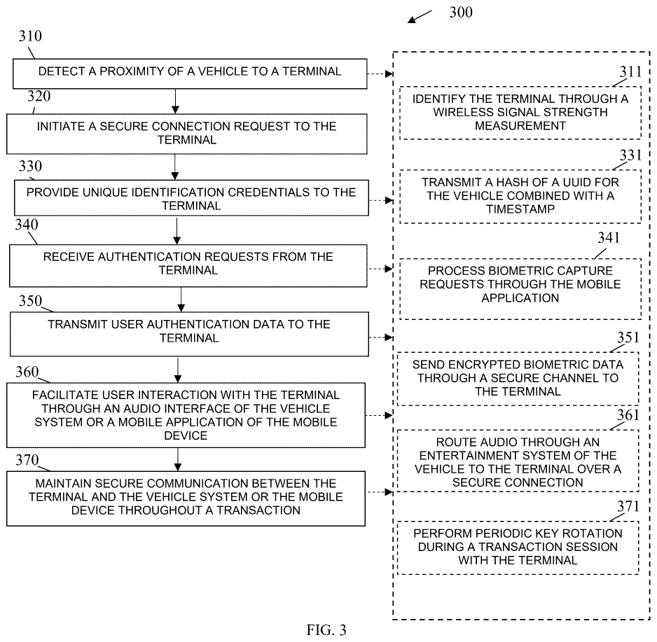

A FIG. 3 is a flow diagram of a method 300 for secure vehicle-terminal transaction processing, according to an example embodiment. The instructions of method 300 are referred to secure vehicle/mobile device transaction manager. The secure vehicle/mobile device transaction manager is executed by one or more processors of a vehicle 120 and/or mobile device 130. In an embodiment, the secure vehicle/mobile device transaction manager is one or more of vehicle system 123, entertainment system 124, and/or mobile application (app) 133. The secure vehicle/mobile device transaction manager interacts with media terminal 110 during a secure transaction being conducted by a user at media terminal 110 from within vehicle 120.

At 320, the secure vehicle/mobile device transaction manager detect a proximity of a vehicle 120 to a media terminal 110. In an embodiment, the secure vehicle/mobile device transaction manager identifies the proximity through a wireless signal strength measurement coming from the wireless transceiver 115 of the media terminal 110.

At 330, the secure vehicle/mobile device transaction manager initiates a secure connection request to the media terminal 110. This is a wireless connection request for wireless communications between the vehicle 120 or the mobile device 130 located within the vehicle and the media terminal 110.

At 340, the secure vehicle/mobile device transaction manager provides unique identification credentials to the media terminal for authentication. In an embodiment, the secure vehicle/mobile device transaction manager transmits a has of a UUID for the vehicle 120 combined with a timestamp. The media terminal 110 then authenticates the unique identification credentials through authenticator 144. Alternatively, transaction manager 113 of media terminal 110 performs the authentication on the unique identification credentials.

In an embodiment, at 341, the secure vehicle/mobile device transaction manager also processes biometric capture of biometrics from the user through the mobile application 133. In an embodiment, the vehicle system 123 captures user biometrics from the user through an in-vehicle microphone 126 to capture a unique phrase spoken by the user or through an image of the user captured by an in-vehicle camera.

At 350, the secure vehicle/mobile device transaction manager transmits user authentication data to the media terminal 110. In an embodiment, at 351, the secure vehicle/mobile device transaction manager sends encrypted biometric data captured from the user through a secure channel to the media terminal 110.

In an embodiment, at 360, the secure vehicle/mobile device transaction manager facilitates user interaction with the media terminal through an audio interface of the vehicle system 123 or the mobile application 133 of the mobile device 130. In an embodiment, at 361, the secure vehicle/mobile device transaction manager routes audio through an entertainment system 124 of the vehicle 120 to the media terminal 110 over a secure wireless connection.

At 370, the secure vehicle/mobile device transaction manager maintains secure communication between the media terminal 110 and the vehicle system 123 or the mobile device 130 throughout a transaction being conducted by the user with the media terminal 110. In an embodiment, at 371, the secure vehicle/mobile device transaction manager performs periodic key rotation during a transaction session with the media terminal 110. That is, the encrypted secure connection is encrypted via a key and the key is periodically changed; the media terminal 110 includes a similar algorithm such that any changed key for encrypted communications is in synch with what the media terminal 110 is expecting for the transaction session. This enhances security and ensures that eavesdroppers are unable to penetrate and compromise the transaction session.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
receiving, by a terminal, a connection request from a vehicle system or a mobile device located within a vehicle, wherein the terminal is a media terminal comprising a wireless transceiver and a media dispenser comprising media cassettes that house banknotes;
measuring, by the terminal, a signal strength of the connection request and calculating, from the signal strength, a distance between the vehicle and the terminal;
denying, by the terminal, the connection request when the calculated distance is not within a preconfigured threshold distance;
establishing, by the terminal, a secure communication channel with the vehicle system or the mobile device using unique identifier verification, wherein the unique identifier verification comprises validating a vehicle identification number (VIN) of the vehicle as a VIN previously registered to an account of a user for in-vehicle transaction processing at the terminal and, responsive to validating the VIN, generating an encrypted session key for the secure communication channel;
authenticating, by the terminal, the user based on multiple authentication factors including at least one biometric factor and verification of the vehicle system or mobile device credentials;
receiving, by the terminal, transaction instructions through voice commands captured by a microphone of the vehicle and transmitted through the secure communication channel;
processing, by the terminal, the transaction instructions by converting the voice commands into transaction data using a natural language processor;
periodically changing, by the terminal during a transaction session, an encryption key used to encrypt communications through the secure communication channel in synchronization with a corresponding change of the encryption key by the vehicle system or the mobile device; and
completing, by the terminal, a requested transaction while maintaining secure communication with the vehicle system or the mobile device, wherein completing the requested transaction comprises moving banknotes from at least one of the media cassettes and dispensing the banknotes to the user while the user remains within the vehicle, and providing audio feedback through a speaker of the vehicle.

2. The method of claim 1, wherein receiving the connection request comprises detecting a wireless signal including a unique media access control (MAC) address from the vehicle system.

3. The method of claim 1, wherein establishing the secure communication channel comprises validating a vehicle identification number (VIN) and generating an encrypted session key.

4. The method of claim 1, wherein authenticating the user comprises verifying a personal identification number (PIN) entered through a mobile application of the mobile device and matching stored biometric data.

5. The method of claim 1, wherein receiving the transaction instructions comprises processing voice commands received through a microphone associated with the vehicle system.

6. The method of claim 1, wherein processing the transaction instructions comprises converting voice commands to transaction data using natural language processing.

7. The method of claim 1, wherein completing the requested transaction comprises providing audio feedback through a speaker system of a vehicle associated with the vehicle system.

8. The method of claim 1, further comprising verifying a location of a vehicle associated with the vehicle system relative to the terminal.

9. The method of claim 1, further comprising encrypting communications between the terminal and the vehicle system using public-private key encryption.

10. The method of claim 1, further comprising maintaining session security through continuous monitoring of a connection with the vehicle system.

11. The method of claim 1, further comprising providing transaction confirmation through both audio feedback of the vehicle system and mobile application notification.

12. A method, comprising:
detecting, by a vehicle system or a mobile device located within a vehicle, a proximity of the vehicle to a terminal, wherein the terminal is a media terminal comprising a media dispenser having media cassettes that house banknotes, and wherein detecting the proximity comprises measuring a signal strength of a wireless signal received from a wireless transceiver of the terminal;
initiating, by the vehicle system or the mobile device, a secure connection request to the terminal;
providing, by the vehicle system or the mobile device, unique identification credentials to the terminal, wherein the unique identification credentials comprise a hash of a universally unique identifier (UUID) of a wireless transceiver of the vehicle or the mobile device combined with a current date and time of day;
receiving, by the vehicle system or the mobile device, authentication requests from the terminal;
transmitting, by the vehicle system or the mobile device, user authentication data to the terminal, wherein the user authentication data comprise encrypted biometric data captured from a user through a microphone or a camera of the vehicle or the mobile device;
facilitating, by the vehicle system or the mobile device, user interaction with the terminal through an audio interface of the vehicle system or a mobile application of the mobile device, wherein facilitating the user interaction comprises transmitting, to the terminal through a secure communication channel, voice input captured by a microphone of the vehicle as transaction instructions and routing audio received from the terminal through an entertainment system of the vehicle for playback through a speaker of the vehicle;
periodically changing, by the vehicle system or the mobile device during a transaction session, an encryption key used to encrypt communications through the secure communication channel in synchronization with a corresponding change of the encryption key by the terminal; and
maintaining, by the vehicle system or the mobile device, secure communication between the terminal and the vehicle system or the mobile device throughout a transaction, including while the terminal moves banknotes from at least one of the media cassettes and dispenses the banknotes to the user while the user remains within the vehicle.

13. The method of claim 12, wherein detecting the proximity comprises identifying the terminal through a wireless signal strength measurement.

14. The method of claim 12, wherein providing the unique identification credentials comprises transmitting a hash of a universally unique identifier (UUID) for the vehicle combined with a timestamp.

15. The method of claim 12, wherein receiving the authentication requests comprises processing biometric capture requests through the mobile application.

16. The method of claim 12, wherein transmitting the user authentication data comprises sending encrypted biometric data through a secure channel to the terminal.

17. The method of claim 12, wherein facilitating the user interaction comprises routing audio through an entertainment system of the vehicle to the terminal over a secure connection.

18. The method of claim 12, wherein maintaining the secure communication comprises performing periodic key rotation during a transaction session with the terminal.

19. A system, comprising:
a terminal comprising:
a processor;
a memory;
a wireless communication interface;
a transaction processing module;
a media dispenser comprising media cassettes configured to house and dispense banknotes;
natural language processor;
a vehicle system or mobile device located within a vehicle comprising:
a processor;
a memory;
a wireless communication interface; and
an audio system, the audio system comprising a microphone and a speaker of the vehicle;
wherein the terminal and the vehicle system or mobile device are configured to establish secure communication using unique identifiers, authenticate a user through multiple factors, and process transactions through voice commands provided within the vehicle;
wherein the terminal is configured to measure a signal strength of a connection request received from the vehicle system or the mobile device, calculate a distance between the vehicle and the terminal from the signal strength, and deny the connection request when the calculated distance is not within a preconfigured threshold distance;
wherein the unique identifiers comprise a vehicle identification number (VIN) of the vehicle, and the terminal is configured to validate the VIN as a VIN previously registered to an account of the user for in-vehicle transaction processing and, responsive to validating the VIN, generate an encrypted session key for a secure communication channel between the terminal and the vehicle system or mobile device;
wherein the terminal and the vehicle system or mobile device are configured to periodically change, in synchronization with one another during a transaction session, an encryption key used to encrypt communications through the secure communication channel; and
wherein the transaction processing module is configured to convert, using the natural language processor, voice commands captured by the microphone of the vehicle and received through the secure communication channel into transaction instructions, cause the media dispenser to move banknotes from at least one of the media cassettes and dispense the banknotes to the user while the user remains within the vehicle, and provide audio feedback through the speaker of the vehicle.

20. The system of claim 19, wherein the terminal further comprises a natural language processing module for converting voice commands received through the vehicle system into transaction instructions.
